(19) United States
(12) Patent Application Publication
(10) Pub. No.: US 2007/0085766 A1
(43) Pub. Date: Apr. 19, 2007

(54) Method of driving plasma display apparatus

(75) Inventor: Ji-seung Yoo, Yongin-si (KR)

Correspondence Address: FLESHNER & KIM, LLP, P.O. BOX 221200, CHANTILLY, VA, 20153, US

(73) Assignee: LG ELECTRONICS INC.

(21) Appl. No.: 11/581,358

(22) Filed: Oct. 17, 2006

(30) Foreign Application Priority Data
Oct. 18, 2005 (KR) 10-2005-0098342

(51) Int. Cl. G09G 3/28

(52) U.S. Cl. 345/63

(57) ABSTRACT

A method of driving a plasma display apparatus is provided. When the plasma display apparatus is driven by dividing a frame into a plurality of subfield groups including one or more subfields, a portion of all scan electrodes is scanned during an address period of at least one subfield of the plurality of subfield groups.

This Nonprovisional application claims priority under 35 U.S.C. § 119(a) on Patent Application No. 10-2005-0098342 filed in Korea on Oct. 18, 2005 the entire contents of which are hereby incorporated by reference.

### BACKGROUND

1. Field

This document relates to a method of driving a plasma display apparatus.

2. Description of the Background Art

A plasma display panel (hereinafter, referred to as “PDP”) displays images including characters and/or graphics by emitting phosphors with ultraviolet rays of 147 nm generated during the discharge of an inert mixed gas such as He+Xe or Ne+Xe.

FIG. 1 illustrates a perspective view of the construction of a related art three-electrode AC surface discharge type PDP.

Referring to FIG. 1, the three-electrode AC surface discharge type PDP 100 comprises scan electrodes 11a and sustain electrodes 12a formed on an upper substrate 10, and address electrodes 22 formed on a lower substrate 20.

Each of the scan electrodes 11a and each of the sustain electrode 12a are comprised of a transparent electrode such as indium-tin-oxide (ITO). Metal bus electrodes 11b, 12b for reducing resistance are formed in the scan electrodes 11a and the sustain electrode 12a, respectively.

An upper dielectric layer 13a and a protection film 14 are laminated on the upper substrate 10 having the scan electrodes 11a and the sustain electrode 12a formed thereon.

Wall charges generated during the discharge of plasma are accumulated on the upper dielectric layer 13a. A protection film 14 serves to prevent damage to the upper dielectric layer 13a due to sputtering generated during the discharge of plasma and also to increase emission efficiency of secondary electrons.

The protective layer 14 is usually formed of oxide magnesium (MgO).

On the lower substrate 20 having the address electrodes 22 formed thereon are formed a lower dielectric layer 13b and barrier ribs 21.

A phosphor layer 23 is coated on the surface of the lower dielectric layer 13b and the barrier ribs 21.

The address electrodes 22 are disposed to intersect the scan electrodes 11a and the sustain electrode 12a.

The barrier ribs 21 are formed parallel to the address electrodes 22 and serve to prevent ultraviolet rays and a visible rays, which are generated during the discharge, from leaking toward adjacent discharge cells.

The phosphor layer 23 is excited with ultraviolet rays generated during the discharge of plasma to generate one of red (R), green (G) and blue (B) visible rays.

An inert mixed gas for discharging gas, such as He+Xe or Ne+Xe, is injected into discharge spaces of the discharge cells, which are partitioned between the upper substrate 10 and the barrier ribs 21 and between the lower substrate 20 and the barrier ribs 21.

A driving method of the conventional PDP constructed above will be described below with reference to FIG. 2.

FIG. 2 illustrates a driving waveform for illustrating a driving method of the related art PDP.

Referring to FIG. 2, the related art PDP is driven with it being divided into a reset period (RESET) for initializing all cell of the entire screen, an address period (ADDRESS) for selecting a cell of all cell, a sustain period (SUSTAIN) for sustaining the discharge of a selected cell, and an erase period (ERASE) for erasing wall charges remaining within a selected cell.

In the reset period (RESET), a high reset pulse (RST) of the positive polarity is supplied to the sustain electrode Z to generate a reset discharge within cells of the entire screen.

Since wall charges are uniformly accumulated on the cells of the entire screen by the reset discharge, a discharge characteristic becomes uniform.

In the address period (ADDRESS), a data pulse (DATA) is supplied to the address electrodes X. Scan pulses (-SCN) are sequentially provided to the scan electrodes Y in synchronization with the data pulse (DATA).

As a result, as a voltage difference between the data pulse (DATA) supplied to the address electrodes X and the scan pulse (-SCN) supplied to the scan electrodes Y and a wall voltage within the cells are added together, an address discharge is generated in cells to which the data pulse (DATA) is supplied.

In the sustain period (SUSTAIN), a sustain pulse (SUS) is alternately supplied to the scan electrodes Y and the sustain electrode Z one by one.

Therefore, as a voltage of a sustain pulse and a wall voltage within the cells are added together, a sustain discharge is generated in cells to which the sustain pulse is applied.

In the erase period (ERASE), an erase pulse (ERASE) of ramp waveform form is supplied to the entire scan electrodes Y.

The erase pulse serves to erase a sustain discharge and also to uniformly form a constant amount of wall charges within cells of the entire screen.

In the plasma display panel driven with the driving waveform as shown in FIG. 2, a problem arises because flicker usually occurs.

Such flicker is usually generated because the afterglow time of phosphors is shorter than that of a vertical frequency (a frame frequency) of an image signal. For example, assuming that the vertical frequency is 60 Hz, an image of one frame is displayed per 16.67 m/sec.

However, since the response speed of phosphors is faster than 16.67 m/sec, flicker is generated in a screen, resulting degradation of the picture quality.

More particularly, in the PAL (Phase Alternating Line) method, a problem arises because generation of flicker is more profound because the vertical frequency is relatively short, i.e., 50 Hz.

In the PAL method, a scan pulse is supplied to all the scan electrodes during the address period of each subfield, and at the same time, a data pulse is supplied to the address electrode such that a cell to be discharged is selected.

In other words, all the scan electrode lines of the plasma display apparatus are scanned.

Since all the scan electrodes are scanned within a limited duration of time of a frame (i.e., during an address period), it is difficult to improve brightness by increasing the sustain period.

In particular, as a demand for a high-definition and large-sized plasma display panel has been increased, the number of scan electrode lines increases.

As a result, the time required in the scanning of the scan electrode lines lengthens such that the brightness of the plasma display apparatus is not sufficient within the limited duration of time of the frame.

### SUMMARY

Accordingly, an object of the present invention is to solve at least the problems and disadvantages of the background art.

An embodiment of the present invention provides a method of driving a plasma display apparatus capable of driving at high speed through a reduction in the addressing time as well as a reduction of generation of flicker by improving a method of driving a plasma display panel.

In one aspect, there is provided a method of driving a plasma display apparatus, which is driven by dividing one frame into a plurality of subfield groups, comprising scanning a portion of all scan electrodes during an address period of at least one subfield of a plurality of subfield groups.

Implementations may include one or more of the following features. For example, All scan electrodes may be divided into a predetermined number of scan electrode groups, and a portion of the all scan electrode groups may be scanned.

Either odd-numbered scan electrodes or even-numbered scan electrodes may be scanned.

The predetermined number of the scan electrode groups may be equal to or more than two.

The number of scan electrodes in each scan electrode group in the predetermined scan electrode groups may be equal to one another.

The number of scan electrodes in each scan electrode group in the predetermined scan electrode group may be equal to two or three.

The number of scan electrodes belonging to at least one of the predetermined scan electrode groups may be different from the number of scan electrodes belonging to each scan electrode group in the remaining scan electrode groups.

In another aspect, there is provided a method of driving a plasma display apparatus, which is driven by dividing one frame into a plurality of subfield groups, comprising scanning all scan electrodes during an address period of a portion of the subfields belonging to the plurality of subfield groups, and scanning a portion of all scan electrodes during the address period of the remaining subfield of the subfields belonging to the plurality of subfield groups.

Implementations may include one or more of the following features. For example, All scan electrodes may be divided into a predetermined number of scan electrode groups and a portion of the all scan electrode groups may be scanned.

Either the odd-numbered scan electrodes or the even-numbered scan electrodes may be scanned.

All scan electrodes may be divided into a predetermined number of scan electrode groups, and either the odd-numbered scan electrode groups or the even-numbered scan electrode groups may be scanned.

The portion of the subfields belonging to the plurality of subfield groups may be a subfield with a high gray level value, and the remaining subfield of the subfields belonging to the plurality of subfield groups may be a subfield with a low gray level value.

A number of subfields with a low gray level may be one-half of the subfields belonging to one subfield group.

In still another aspect, there is provided a method of driving a plasma display apparatus, which is driven by dividing one frame into a plurality of subfield groups, comprising scanning either the odd-numbered scan electrodes or the even-numbered scan electrodes during an address period of each of the odd-numbered subfields of the plurality of subfields, and scanning the scan electrodes different from the scan electrodes, that are scanned during the address period of each of the odd-numbered subfields, during an address period of each of the even-numbered subfields of the plurality of subfields.

It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 illustrates a perspective view of the construction of a related art three-electrode AC surface discharge type PDP.

FIG. 2 illustrates a driving waveform for illustrating a driving method of the related art PDP.

FIG. 3 illustrates a plasma display apparatus according to a first embodiment of the present invention.

FIG. 4 illustrates a method of driving the plasma display apparatus according to the first embodiment of the present invention.

FIG. 5 illustrates an arrangement of the subfields comprised within a frame according to a gray level weight of subfields.

FIG. 6 illustrates a method of driving the plasma display apparatuss during a predetermined period of each subfield in subfield groups according to the first embodiment of the present invention.

FIG. 7 illustrates a method of driving the plasma display apparatuss during a predetermined period of each subfield in subfield groups according to the second embodiment of the present invention.

FIG. 8a to FIG. 8c illustrates a scanning method of plasma display apparatus according to the second embodiment of the present invention.

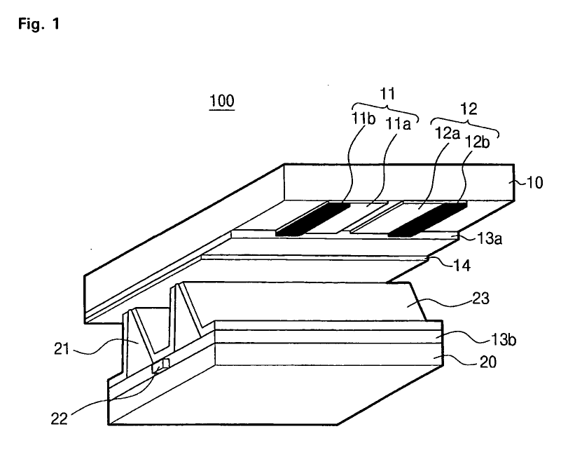

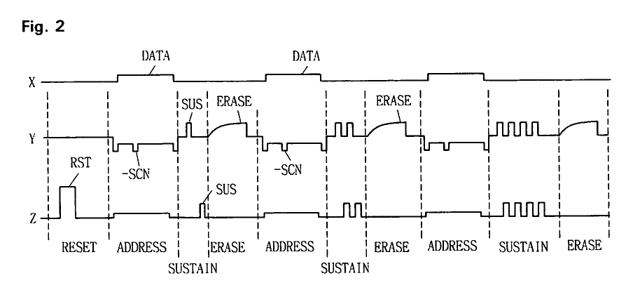

### DETAILED DESCRIPTION OF PREFERRED EMBODIMENTS

Preferred embodiments of the present invention will be described in a more detailed manner with reference to the drawings.

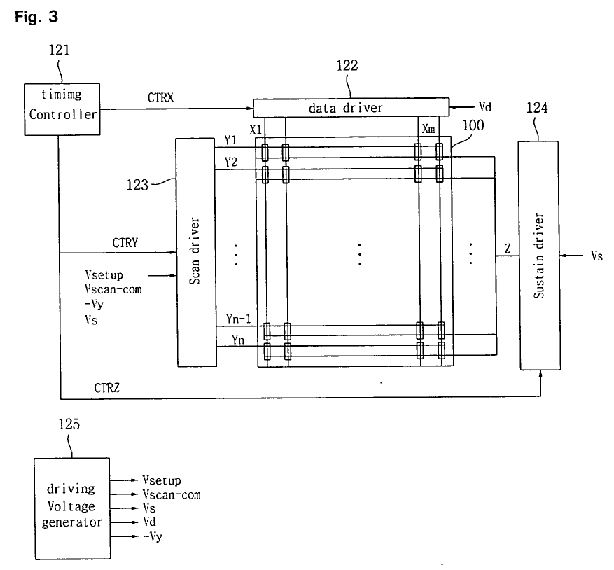

FIG. 3 illustrates a plasma display apparatus according to a first embodiment of the present invention.

As illustrated in FIG. 3, a plasma display apparatus according to a first embodiment of the present invention comprises a plasma display panel 100 comprising scan electrodes Y1 to Yn, sustain electrodes Z and address electrodes X1 to Xm intersecting the scan electrodes Y1 to Yn and the sustain electrodes Z, a data driver 122, a scan driver 123, a sustain driver 124, a timing controller 121 and a driving voltage generator 125.

The data driver 122 supplies data to the address electrodes X1 to Xm formed on a lower substrate (not shown) of the plasma display panel 100.

The scan driver 123 drives scan electrodes Y1 to Yn and the sustain driver 124 drives sustain electrodes Z being common electrodes.

The timing controller 121 controls the data driver 122, the scan driver 123 and the sustain driver 124 when driving the plasma display panel 100.

The driving voltage generating unit 125 supplies a necessary driving voltage to each of the drivers 122, 123 and 124.

The plasma display apparatus of the above-described structure according to the first embodiment of the present invention displays an image due to combination of at least one subfield of a frame during which a driving pulse is supplied to the scan electrodes Yl to Yn, the sustain electrodes Z and the address electrodes X1 to Xm.

The frame is divided into a plurality of subfield groups and each subfield groups comprises one or more subfields.

An upper substrate (not shown) and the lower substrate of the plasma display panel 100 are coalesced with each other at a given distance.

On the upper substrate, a plurality of electrodes, for example, the scan electrodes Y1 to Yn and the sustain electrodes Z are formed in pairs.

On the lower substrate, the address electrodes X1 to Xm are formed to intersect the scan electrodes Y1 to Yn and the sustain electrodes Z.

The data driver 122 receives data mapped in each subfield by a subfield mapping circuit (not shown) after being inverse-gamma corrected and error-diffused through an inverse gamma correction circuit (not shown) and an error diffusion circuit (not shown), or the like.

The data driver 122 samples and latches the mapped data in response to a timing control signal CTRX supplied from the timing controller 121, and then the data to the address electrodes X1 to Xm.

Under the control of the timing controller 121, the scan driver 123 supplies a scan pulse of a scan voltage −Vy to the scan electrodes during an address period.

More specifically, the scan driver 123, under the control of the timing controller 121, does not supply sequentially the scan pulse to all the scan electrodes Y1 to Yn, and sequentially supplies the scan pulse to a portion of all the scan electrodes Y1 to Yn in at least one subfield of a plurality of subfields of a frame.

Further, the scan driver 123 supplies a sustain pulse to the scan electrodes Y1 to Yn during a sustain period.

Under the control of the timing controller 121, the sustain driver 124 supplies a predetermined bias voltage to the sustain electrodes Z during a set-down period of the reset period and the address period.

The sustain driver 124 supplies a sustain pulse to the sustain electrodes Z during the sustain period.

The scan driver 123 and the sustain driver 124 operate alternately with each other during the sustain period.

The timing controller 121 receives a vertical/horizontal synchronization signal and a clock signal, and generates timing control signals CTRX, CTRY and CTRZ for controlling the operation timing and synchronization of each driver 122, 123 and 124. The timing controller 121 supplies the timing control signals CTRX, CTRY and CTRZ to the corresponding drivers 122, 123 and 124 to control each of the drivers 122, 123 and 124.

The data control signal CTRX includes a sampling clock for sampling data, a latch control signal, and a switch control signal for controlling the on/off time of an energy recovery circuit and driving switch elements inside the data driver 122.

The scan control signal CTRY includes a switch control signal for controlling the on/off time of an energy recovery circuit and driving switch elements inside the scan driver 123.

The sustain control signal CTRZ includes a switch control signal for controlling the on/off time of an energy recovery circuit and driving switch elements inside the sustain driver 124.

The driving voltage generating unit 125 generates driving voltages such as a setup voltage Vsetup, a scan common voltage Vscan-com, a scan voltage −Vy, a sustain voltage Vs, a data voltage Vd.

These driving voltages may vary in accordance with the composition of the discharge gas or the structure of the discharge cells.

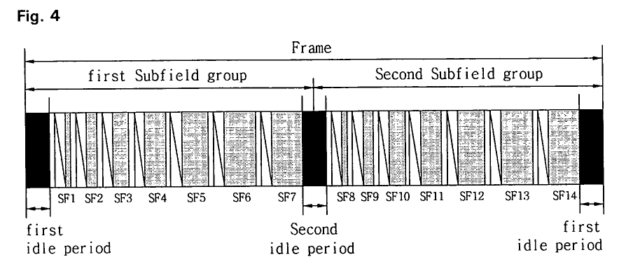

FIG. 4 illustrates a method of driving the plasma display apparatus according to the first embodiment of the present invention.

Referring to FIG. 4, the plasma display apparatus according to the first embodiment of the present invention is driven by dividing a frame into a plurality of subfield groups including one or more subfields and an idle period having a predetermined length is provided between respective subfield groups.

The sub-field group is time-divided into a number of subfields SF1, SF2, SF3, SF4, . . . , each including a reset period, an address period, a sustain period and an erase period. Each sub-field that is time-divided as described above is set to have a predetermined gray level value.

All scan electrode lines may be scanned during an address period of any one of a plurality of subfields and a portion of the scan electrode lines may be scanned during an address period the other one of a plurality of subfields.

Further, a portion of all the scan electrode lines may be scanned during an address period of at least one of the plurality of subfields. Such a driving method is called a partial line addressing (PLA) method in the embodiment of the present invention.

In the first embodiment according to the present invention, any light that is not radiated in the idle period is provided between sub-field groups of the same frame.

Non-standard video signals are processed using deviation in horizontal line sync signals, such as signals generated by a video recorder or a video game machine.

The sub-field groups within the same frame provided in the idle period operate in a consecutive manner without the idle period.

The idle period may exist between the sub-field groups within each frame, as described above, but may exist between respective frames.

In other words, when one frame comprises a first sub-field group and a second sub-field group, a first idle period is provided before the first sub-field group is driven and after the second sub-field group is driven, respectively.

A second idle period is provided between the first sub-field group and the second sub-field group.

The lengths of the first idle period and the second idle period may be set to be different from each other depending on a processing period of a non-standard video signal, but can be set to be the same for the purpose of efficient signal processing.

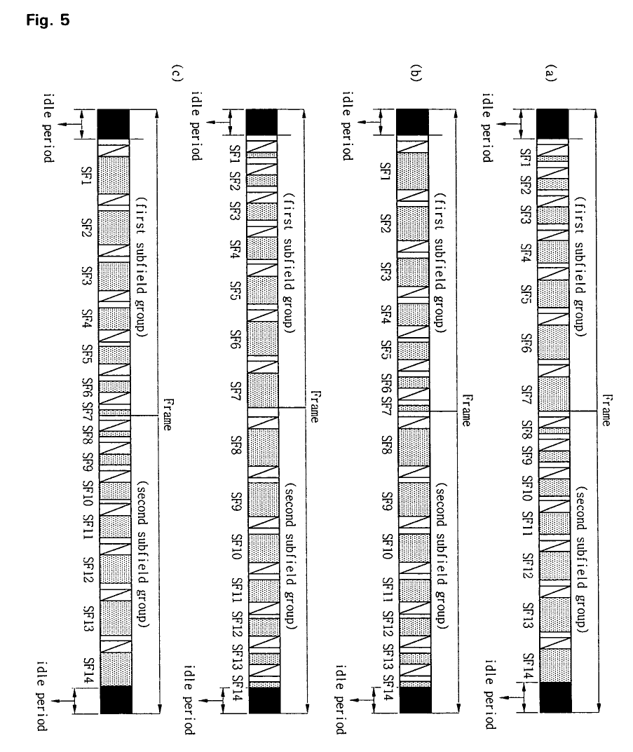

In the first embodiment according to the present invention, the weights of subfields comprised in a frame can be arranged in various types as shown in FIG. 5.

FIG. 5 illustrates an arrangement of the subfields comprised within a frame according to the weights of subfields.

As shown in FIG. 5(a), one frame comprises two or more sub-field groups (not shown). In each sub-field group, sub-fields are arranged within the same group in order from lowest to highest weight.

In other words, sub-fields arranged within each group are arranged in order from lowest to highest gray level values.

As shown in FIG. 5(b), one frame comprises two or more sub-field groups (not shown). In each sub-field group, sub-fields are arranged within the same group in order from highest to lowest weight.

In other words, sub-fields arranged within each group are arranged in order from highest gray level values.

As shown in FIG. 5(c), one frame comprises two or more sub-field groups (not shown). In each sub-field group, sub-fields are arranged within the same group in order by weight.

In other words, sub-fields within any one of sub-field groups can be arranged in order from lowest to highest weight, which are represented by a gray level value, or can be arranged in order from highest to lowest weight, which are represented by a gray level value.

In FIG. 5(c), sub-fields can be arranged in order depending on the weights of the sub-fields and a predetermined rule within a sub-field group in which weights of sub-fields are different. However, weights of sub-fields within each sub-field group can be arranged randomly without a predetermined rule.

As described above, if the weights of the sub-fields within each sub-field group are arranged in various types, flicker as well as pseudo contour noise generated in a motion picture can be prevented and the picture quality will improve accordingly.

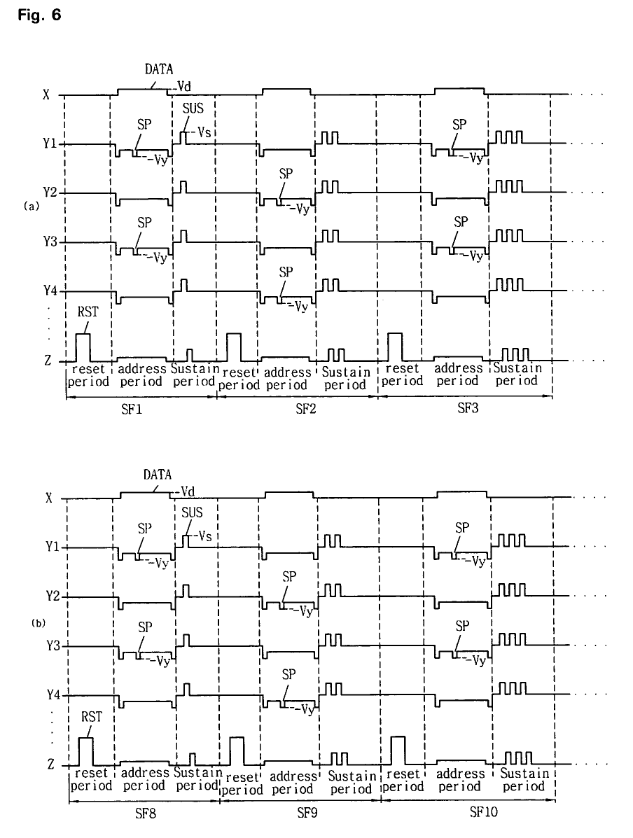

FIG. 6 illustrates a driving pulse applied to scan electrodes during a predetermined period of each subfield in subfield groups according to the first embodiment of the present invention.

FIG. 6(a) illustrates a driving pulse applied to the scan electrodes during the predetermined period of each subfield in a first subfield group of one frame. FIG. 6(b) illustrates a driving pulse applied to the scan electrodes during the predetermined period of each subfield in a second subfield group of one frame.

<First Subfield Group>

(First Subfield)

In the reset period of the first sub-field SF1, a positive high reset pulse or a set-up/set-down pulse (not shown) of ramp signal form, which has a predetermined tilt, is supplied to the sustain electrode Z to generate a reset discharge within cells of the entire screen. As wall charges are uniformly accumulated on the cells of the entire screen by the reset discharge, a discharge characteristic becomes uniform.

During an address period, a scan pulse SP is not supplied to all the scan electrode lines Y1 to Yn, and the scan pulse SP is supplied to a portion of all the scan electrode lines Y1 to Yn. For example, a scan pulse SP is supplied to odd-numbered scan electrode lines Y1, Y3, Y5, . . . of all the scan electrode lines Y1 to Yn.

At this time, a data pulse DATA synchronized with the scan pulse SP is supplied to the address electrodes X. As the voltage difference between the scan pulse SP and the data pulse DATA is added to the wall voltage generated during the reset period, an address discharge is generated within the discharge cells to which the data pulse is supplied.

In FIG. 6, the scan pulse SP is supplied to the odd-numbered scan electrode lines Y1, Y3, Y5, . . . of all the scan electrode lines Y1 to Yn. However, the scan pulse SP may be supplied to even-numbered scan electrode lines Y2, Y4, Y6, . . . of all the scan electrode lines Y1 to Yn such that an address discharge may be generated within the discharge cells to which the data pulse DATA is supplied.

Wall charges are formed inside the cells selected by performing the address discharge such that when a sustain voltage Vs is applied a discharge occurs.

During the sustain period, a sustain pulse SUS is alternately supplied to the scan electrode and the sustain electrode.

As the wall voltage within the cells selected by performing the address discharge is added to the sustain pulse SUS, every time the sustain pulse SUS is applied, a sustain discharge is generated in the cells selected during the address period.

After the sustain discharge is completed, an erase period may be included in each subfield in accordance with a discharge characteristic of the plasma display panel.

During the erase period, an erase ramp pulse (not showm) having a small pulse width and a low voltage level may be supplied to the sustain electrode or the scan electrode, thereby making it possible to erase the remaining wall charges within all the cells.

<Second, Third, Fourth, . . . Subfields>

Since a driving method performed during a reset period and a sustain period of each of second, third, fourth, . . . subfields SF2, SF3, SF4, . . . is the same as the driving method performed during the reset period and the sustain period of the first subfield, a description thereof is omitted.

In the same way as the first subfield, during an address period of each of the second, third, fourth, . . . subfields SF2, SF3, SF4, . . . , a scan pulse SP is not supplied to all the scan electrode lines Y1 to Yn, and the scan pulse SP is supplied to a portion of all the scan electrode lines Y1 to Yn. For example, a scan pulse SP may be supplied to the odd- numbered scan electrode lines Y1, Y3, Y5, . . . of all the scan electrode lines Y1 to Yn. Otherwise, the scan pulse SP may be supplied to the even-numbered scan electrode lines Y2, Y4, Y6, . . . of all scan electrode lines Y1 to Yn. Preferably, during an address period of each of odd-numbered subfields, a scan pulse is supplied to either odd-numbered scan electrode lines or even-numbered scan electrode lines. Then, during an address period of each of even-numbered subfields, a scan pulse is supplied to the scan electrode lines to which the scan pulse is not supplied during the address period of each of the odd-numbered subfields.

Although it is not illustrated in the drawings, during the address period of each of the second, third, fourth, . . . subfields SF2, SF3, SF4, . . . , the scan pulse may be supplied to all the scan electrode lines.

This prevents a reduction in image quality capable of being caused by the PLA method.

In other words, the scan pulse is supplied to a portion of all the scan electrode lines during the address period of the first subfield, and the scan pulse is supplied to all the scan electrode lines during the address period of each of the remaining subfields.

At this time, a subfield, in which the scan pulse is supplied to a portion of all the scan electrode lines, is not limited to the first subfield. Further, the number of selected subfields may be set to a predetermined number.

Further, a subfield, in which the scan pulse is supplied to a portion of all the scan electrode lines, may be selected in accordance with gray level weight the subfield.

For example, while the scan pulse may be supplied to a portion of all the scan electrode lines in a subfield with low gray level weight, the scan pulse may be supplied to all the scan electrode lines in a subfield with high gray level weight.

A number of subfields with a low gray level weight may be not fixed in accordance with the specific critical gray level weight of a subfield.

Preferably, a number of subfields with a low gray weight is one-half of the subfields belonging to one subfield group.

<Second Subfield Group>

Since a driving method performed during each subfield SF8, SF9, SF10, . . . in the second subfield group is the same as the driving method performed during each subfield SF8, SF9, SF10, . . . in the second subfield, a description thereof is omitted.

Since the structure of a plasma display apparatus according to a second embodiment of the present invention is the same as the structure of a plasma display apparatus according to the first embodiment of the present invention, a description thereof is omitted.

In the plasma display apparatus according to the second embodiment of the present invention, all scan electrodes are divided into a predetermined number of scan electrode groups, and a scan driver supplies a scan pulse to a portion of all the scan electrode groups during an address period.

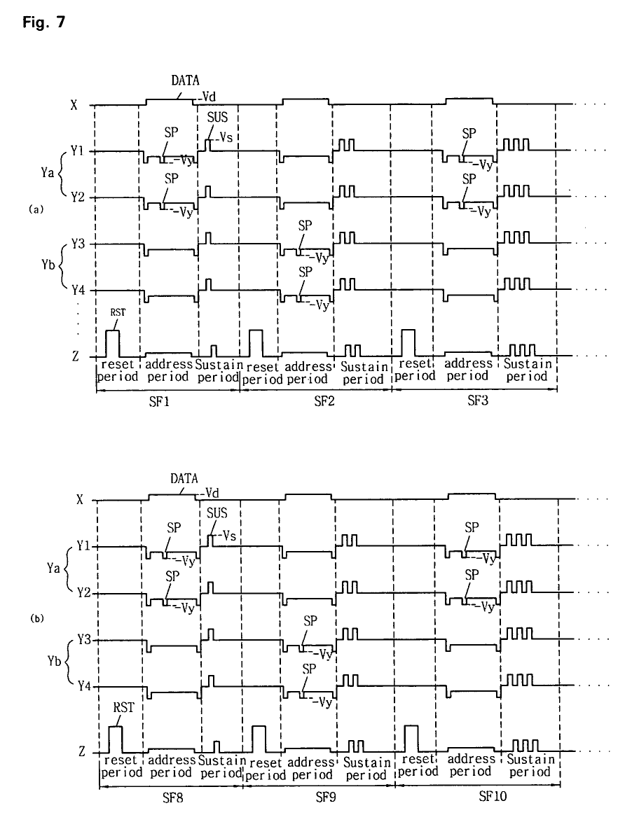

FIG. 7 illustrates a driving pulse applied to scan electrodes during a predetermined period of each subfield in subfield groups according to the second embodiment of the present invention.

<First Subfield Group>

(First Subfield)

Since a driving method performed during a reset period and a sustain period of a first subfield SF1 according to the second embodiment of the present invention is the same as the driving method performed during the reset period and the sustain period of the first subfield according to the first embodiment of the present invention, a description thereof is omitted.

All the scan electrodes are divided into a predetermined number of scan electrode groups, and a scan pulse is supplied to a portion of all the scan electrode groups during an address period.

More specifically, during an address period, a scan pulse SP is supplied to either odd-numbered scan electrode groups Ya, Yc, Ye, . . . or even-numbered scan electrode groups Yb, Yd, Yf, . . .of all the scan electrode groups. At this time, a data pulse DATA synchronized with the scan pulse SP is supplied to address electrodes X.

As the voltage difference between the scan pulse SP and the data pulse DATA is added to the wall voltage generated during the reset period, an address discharge is generated within discharge cells to which the data pulse is supplied.

<Second, Third, Fourth, . . . Subfields>

Since a driving method performed during a reset period and a sustain period of each of second, third, fourth, . . . subfields SF2, SF3, SF4, . . . according to the second embodiment of the present invention is the same as the driving method performed during the reset period and the sustain period of the first subfield according to the first embodiment of the present invention, a description thereof is omitted.

In the same way as the first subfield, during an address period of each of the second, third, fourth, . . . subfields SF2, SF3, SF4, . . . , a scan pulse SP is not supplied to all the scan electrode groups, and the scan pulse SP is supplied to a portion of all the scan electrode groups.

For example, a scan pulse SP is supplied to either the odd-numbered scan electrode groups Ya, Yc, Ye, . . . or the even-numbered scan electrode groups Yb, Yd, Yf, . . .of all the scan electrode groups.

Preferably, during an address period of each of odd-numbered subfields, a scan pulse is supplied to either odd-numbered scan electrode groups or even-numbered scan electrode groups. Then, during an address period of each of even-numbered subfields, a scan pulse is supplied to the scan electrode groups to which the scan pulse is not supplied during the address period of each of the odd-numbered subfields. In the same way as the first embodiment, during the address period of each of the second, third, fourth, . . . subfields SF2, SF3, SF4, . . . , the scan pulse may be supplied to all the scan electrode groups.

This prevents a reduction in image quality capable of being caused by the PLA method.

In other words, the scan pulse is supplied to a portion of all the scan electrode groups during the address period of the first subfield, and the scan pulse is supplied to all the scan electrode groups during the address period of each of the remaining subfields.

At this time, a subfield, in which the scan pulse is supplied to a portion of all the scan electrode groups, is not limited to the first subfield. Further, the number of selected subfields may be set to a predetermined number.

Further, a subfield, in which the scan pulse is supplied to a portion of all the scan electrode groups, may be selected in accordance with gray level weight. Since this was described in detail in the first embodiment of the present invention, a description thereof is omitted.

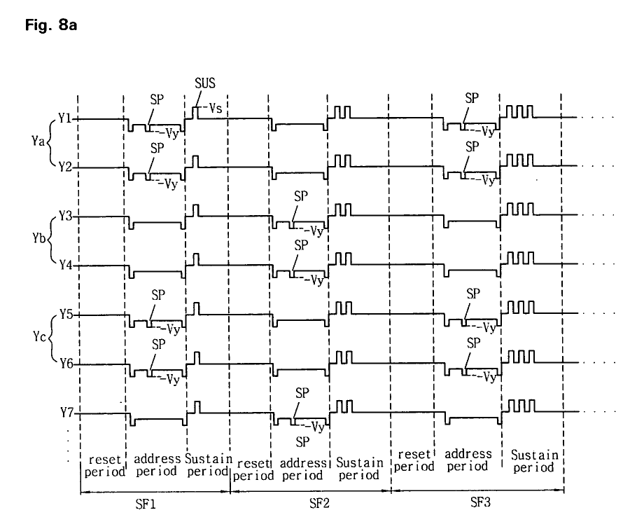

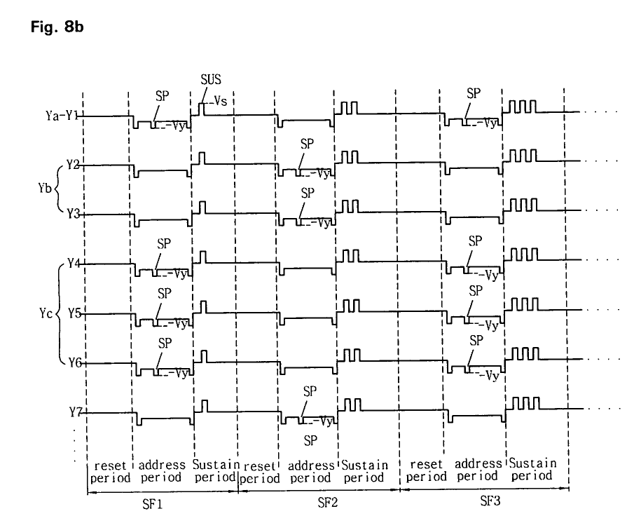

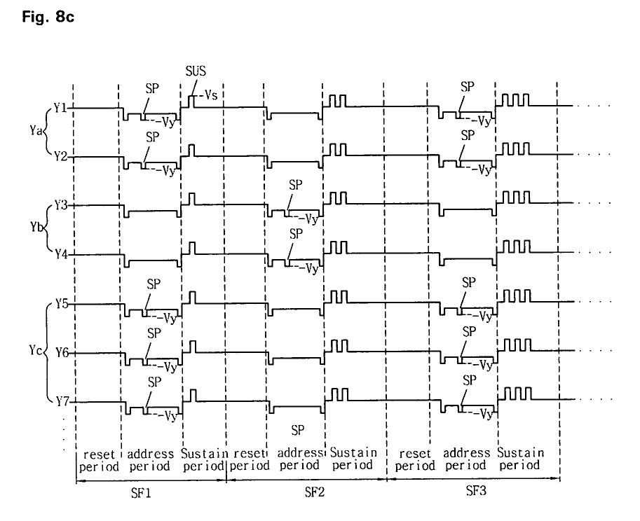

FIGS. 8a to 8c illustrate a scanning method of a scan driver of a plasma display apparatus according to a second embodiment of the present invention.

As illustrated in FIGS. 4a to 4c, when all the scan electrodes are divided into a predetermined number of scan electrode groups, the number of scan electrode groups is equal to at least two.

Preferably, the number of scan electrode groups is equal to one half or one third of all the scan electrodes.

The number of scan electrodes belonging to each of all the scan electrode groups may be equal to one another as illustrated in FIG. 4a, or may be different from one another as illustrated in FIG. 4b.

Further, as illustrated in FIG. 4c, the number of scan electrodes belonging to a portion of all the scan electrode groups may be equal to one another, and the number of scan electrodes belonging to the remaining scan electrode groups may be different from one another.

In other words, the number of scan electrodes belonging to at least one of all the scan electrode groups is different from the number of scan electrodes belonging to the remaining scan electrode groups.

As described above, the plasma display apparatus according to the embodiments of the present invention employs a single scanning method, which is more effective than a dual scanning method, to reduce the addressing time.

The single scanning method performs an addressing operation using a single data driver, and the dual scanning method performs an addressing operation on the plasma display panel divided into two regions using two data drivers.

Further, since the plasma display panel is not divided in the single scanning method, the number of drivers required to drive the plasma display panel in the single scanning method is less than the number of drivers required to drive the plasma display panel in the dual scanning method. Accordingly, the manufacturing cost is reduced.

Further, since the driving method of the plasma display apparatus according to the embodiments of the present invention reduces the addressing time, the duration of the sustain period lengthens such that the brightness of the plasma display apparatus is improved.

Further, the driving method of the plasma display apparatus according to the embodiments of the present invention reduces a flicker because the weights of the subfields may be arranged in various types in each sub-field group.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of driving a plasma display apparatus comprising:
dividing a frame into a plurality of subfield groups; and
scanning a portion of all scan electrodes during an address period of at least one subfield of a plurality of subfield groups.

2. The method of claim 1,
wherein all scan electrodes are divided into a predetermined number of scan electrode groups and a portion of the all scan electrode groups are scanned.

3. The method of claim 1,
wherein either odd-numbered scan electrodes or even-numbered scan electrodes are scanned.

4. The method of claim 2,
wherein the predetermined number of the scan electrode groups is equal to or more than two.

5. The method of claim 2,
wherein the number of scan electrodes in each scan electrode group in the predetermined scan electrode groups is equal to one another.

6. The method of claim 5,
wherein the number of scan electrodes in each scan electrode group in the predetermined scan electrode group is equal to two or three.

7. The method of claim 2,
wherein the number of scan electrodes belonging to at least one of the predetermined scan electrode groups is different from the number of scan electrodes belonging to each scan electrode group in the remaining scan electrode groups.

8. The method of claim 1,
wherein an idle period having a predetermined length is provided between the frames and the subfield groups of the frame are continuously arranged within the same frame.

9. The method of claim 1,
wherein a first idle period having a predetermined length is provided between the frames, and a second idle period having a predetermined length is additionally provided between the subfield groups in the same frame.

10. The method of claim 9,
wherein the length of the first idle period equals the length of the second idle period.

11. The method of claim 1,
wherein the plurality of subfield groups include a plurality of subfields and the plurality of subfield groups are arranged in the increasing order of a gray level value of the subfields or the decreasing order of a gray level value of the subfields within each subfield group.

12. The method of claim 1,
wherein one frame is divided into two subfield groups.
wherein the two subfield groups include a plurality of subfields and the plurality of subfields of at least one of the two subfield groups are arranged in the increasing order of a gray level value of the subfields or the decreasing oreder of a gray level value of the subfields.

13. The method of claim 1,
wherein a portion of all scan electrodes are scanned within a low gray level value of subfields.

14. A method of plasma display apparatus comprising;
dividing one frame into a plurality of subfield groups;
scanning all scan electrodes during an address period of a portion of the subfields belonging to the plurality of subfield groups;
scanning a portion of all scan electrodes during the address period of the remaining subfield of the subfields belonging to the plurality of subfield groups.

15. The method of claim 14,
wherein all scan electrodes are divided into a predetermined number of scan electrode groups.
wherein a portion of the all scan electrode groups are scanned.

16. The method of claim 14,
wherein either the odd-numbered scan electrodes or the even-numbered scan electrodes are scanned.

17. The method of claim 14,
wherein all scan electrodes are divided into a predetermined number of scan electrode groups.
wherein either the odd-numbered scan electrode groups or the even-numbered scan electrode groups are scanned.

18. The method of claim 14
wherein the portion of the subfields belonging to the plurality of subfield groups is a subfield with a high gray level value.
wherein the remaining subfield of the subfields belonging to the plurality of subfield groups is a subfield with a low gray level value.

19. The method of claim 18,
whrerein a number of subfields with a low gray level is one-half of the subfields belonging to one subfield group.

20. A method of plasma display apparatus comprising;
dividing one frame into a plurality of subfield groups;
scanning either the odd-numbered scan electrodes or the even-numbered scan electrodes during an address period of each of the odd-numbered subfields of the plurality of subfields; and
scanning the scan electrodes different from the scan electrodes, that are scanned during the address period of each of the odd-numbered subfields, during an address period of each of the even-numbered subfields of the plurality of subfields.
